(19) United States
(12) Patent Application Publication
(10) Pub. No.: US 2023/0129392 A1
(43) Pub. Date: Apr. 27, 2023

(54) OCTAL SMALL FORM FACTOR PLUGGABLE AND ASSEMBLY METHOD THEREOF

(71) Applicant: CLOUD LIGHT TECHNOLOGY LIMITED, Hong Kong (HK)

(72) Inventors: JEN-KAI TSAI, New Taipei City (TW); MING-HSING CHUNG, New Taipei City (TW)

(21) Appl. No.: 17/510,416

(22) Filed: Oct. 26, 2021

(51) Int. Cl. G02B 6/38

(52) U.S. Cl. CPC G02B 6/387

(57) ABSTRACT

An octal small form factor pluggable (OSFP) and an assembly method thereof are provided. The OSFP includes a base, spacer and lid. The base includes four optical fiber ports located at four corners of an imaginary rectangle, respectively, a receiving portion and a holder. The optical fiber ports are disposed at a front end of the base. The receiving portion is near the optical fiber ports and has a receiving space. The holder is in the receiving space and near two lower ones of the optical fiber ports. Two terminal-shaped dent portions are disposed on the holder and near the two lower optical fiber ports. The spacer is disposed above the holder. Terminal-shaped recess portions are disposed on the spacer, with lower ones clamping terminals together with the dent portions, and upper ones lying near the two upper optical fiber ports. The lid covers the receiving portion.

### BACKGROUND OF THE INVENTION

### 1. Field of the Invention

The present disclosure relates to light signal connectors, and in particular to an octal small form factor pluggable (OSFP) 4.0 specification and an assembly method thereof.

### 2. Description of the Related Art

The octal small form factor pluggable (OSFP) Multi Source Agreement (MSA) group announced the release of the OSFP 4.0 Specification for 800G OSFP modules. While the OSFP module was designed from the beginning to support 800G performance, the OSFP 4.0 specification adds support for 2×400G and 8×100G new module definitions of dual 400G and octal 100G breakout modules with dual LC (local connector), dual Mini-LC, dual MPO (multi push on) and octal SN/MDC (Senko Nano/Mini-Duplex Connector) fiber connector options.

However, the OSFP 4.0 specification does not state how to solve the problems with production, manufacturing and assembly, for example, the distance and tolerance between optical fiber ports, and the tolerance between a casing and the optical fiber ports.

### BRIEF SUMMARY OF THE INVENTION

An objective of the present disclosure is to solve problems with conventional octal small form factor pluggables (OSFP) by providing an octal small form factor pluggable (OSFP) effective in eliminating tolerance.

To achieve at least the above objective, the present disclosure provides an octal small form factor pluggable (OSFP), comprising: a base comprising four optical fiber ports located at four corners of an imaginary rectangle, respectively, a receiving portion and a holder, the four optical fiber ports being disposed at a front end of the base, the receiving portion being positioned proximate to the four optical fiber ports and having a receiving space, with the holder disposed in the receiving space and positioned proximate to two lower ones of the four optical fiber ports, wherein two dent portions corresponding in shape to terminals are disposed on an upper surface of the holder and correspond in position to the two lower optical fiber ports; a spacer disposed above the holder, wherein two lower recess portions corresponding in shape to terminals are disposed on a lower surface of the spacer and adapted to clamp the terminals together with the dent portions, wherein two upper recess portions corresponding in shape to terminals are disposed on an upper surface of the spacer and positioned proximate to two upper ones of the four optical fiber ports; and a lid for covering the receiving portion.

In an embodiment of the present disclosure, the upper surface of the holder further has two transverse grooves crossing the dent portions, respectively.

In an embodiment of the present disclosure, the lower surface of the spacer further has two transverse grooves crossing the upper recess portions, respectively.

In an embodiment of the present disclosure, the upper surface of the spacer further has two transverse grooves crossing the lower recess portions, respectively.

In an embodiment of the present disclosure, the holder has two fastening holes, whereas the spacer and the lid each have two through holes corresponding in position to the two fastening holes.

In an embodiment of the present disclosure, a bottom of the receiving portion has an oblique surface.

The present disclosure further provides an assembly method of an octal small form factor pluggable (OSFP), the octal small form factor pluggable (OSFP) having a base, a spacer and a lid, the assembly method comprising the steps of: positioning two terminals at two dent portions on a holder of the base, respectively; positioning the spacer in the holder; positioning two other terminals at two upper recess portions on the spacer, respectively; and covering the base with the lid.

In an embodiment of the present disclosure, the assembly method further comprises fastening the lid and the spacer to the holder.

According to the present disclosure, the octal small form factor pluggable (OSFP) 100 with the 4.0 specification is essentially dismantled into three constituent elements, namely the base, spacer and lid, such that the four optical fiber ports are fixed to the base. The four optical fiber ports do not have assembly tolerance therebetween, neither do the four optical fiber ports and base. The base and the spacer each clamp four terminals. Therefore, not only is it easy and convenient to assemble the octal small form factor pluggable (OSFP), but its constituent elements can also be easily produced and demolded.

### BRIEF DESCRIPTION OF THE DRAWINGS

FIG. 1 is a perspective view of an octal small form factor pluggable (OSFP) in an embodiment of the present disclosure.

FIG. 2 is an exploded view of the octal small form factor pluggable (OSFP) in an embodiment of the present disclosure.

FIG. 3A is a perspective view of a holder in an embodiment of the present disclosure.

FIG. 3B is a perspective view of a spacer in an embodiment of the present disclosure.

FIG. 4 is a first schematic view of the octal small form factor pluggable (OSFP) during assembly thereof in an embodiment of the present disclosure.

FIG. 5 is a second schematic view of the octal small form factor pluggable (OSFP) during assembly thereof in an embodiment of the present disclosure.

FIG. 6 is a third schematic view of the octal small form factor pluggable (OSFP) during assembly thereof in an embodiment of the present disclosure.

FIG. 7 is a schematic view of the process flow of an assembly method of an octal small form factor pluggable (OSFP) in an embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

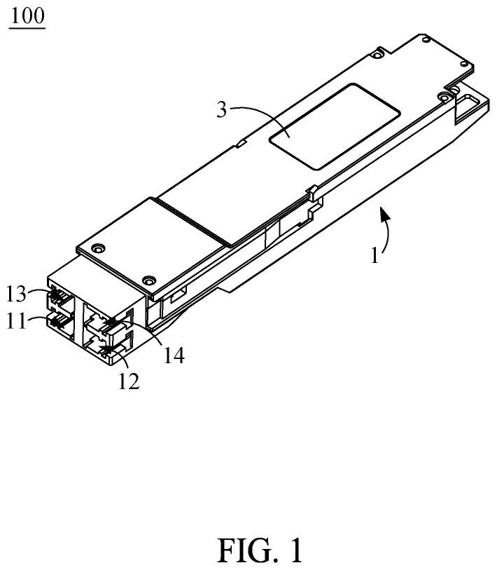

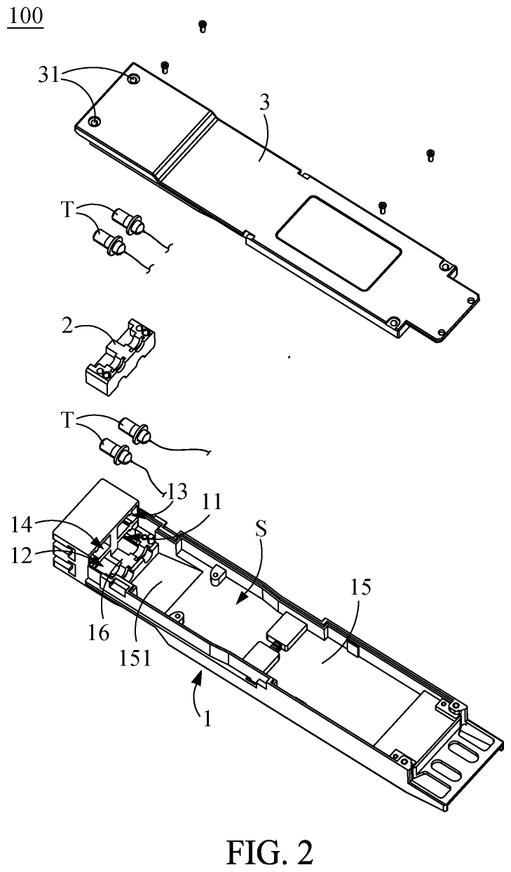

Referring to FIG. 1 and FIG. 2, an octal small form factor pluggable (OSFP) 100 in an embodiment of the present disclosure comprises a base 1, a spacer 2 and a lid 3.

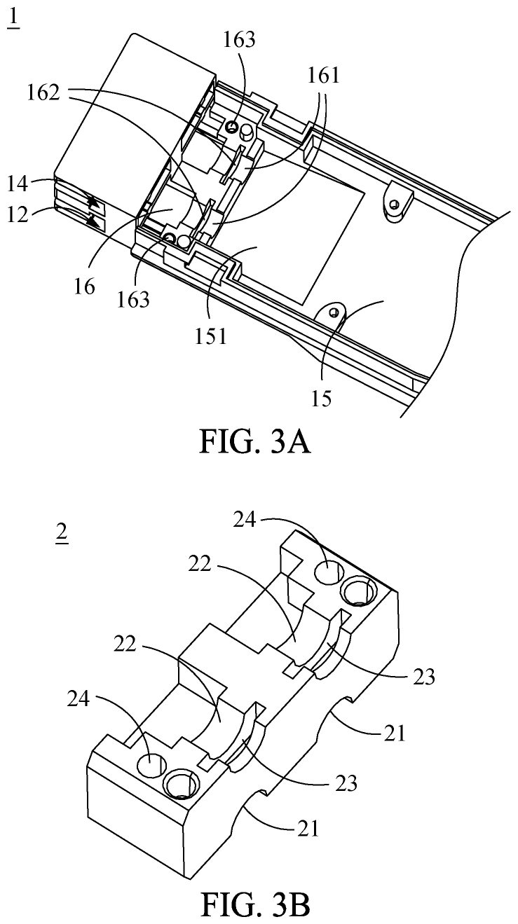

Referring to FIG. 2 and FIG. 3A, the base 1 is integrally formed and comprises four optical fiber ports 11, 12, 13, 14 located at the four corners of an imaginary rectangle, respectively, a receiving portion 15 and a holder 16. The four optical fiber ports 11, 12, 13, 14 are disposed at the front end of the base 1. The receiving portion 15 is near the four optical fiber ports 11, 12, 13, 14 and has a receiving space S. The holder 16 is disposed in the receiving space S and positioned proximate to the two lower ones of the four optical fiber ports 11, 12, 13, 14, namely the optical fiber ports 11, 12. Two dent portions 161 corresponding in shape to terminals T are disposed on the upper surface of the holder 16 and correspond in position to the optical fiber ports 11, 12.

Referring to FIG. 2 and FIG. 3B, the spacer 2 is disposed above the holder 16. Two lower recess portions 21 corresponding in shape to terminals T are disposed on the lower surface of the spacer 2. The lower recess portions 21 and the dent portions 161 clamp the terminals T. Two upper recess portions 22 corresponding in shape to terminals are disposed on the upper surface of the spacer 2 and correspond in position to the two upper ones of the four optical fiber ports 11, 12, 13, 14, namely the optical fiber ports 13, 14.

In this embodiment, terminals T are LC terminals (LC receptacle) and are in substantially cylindrical shape, but the present disclosure is not limited thereto. In a variant embodiment, terminals T are any other types of terminals in any other shapes.

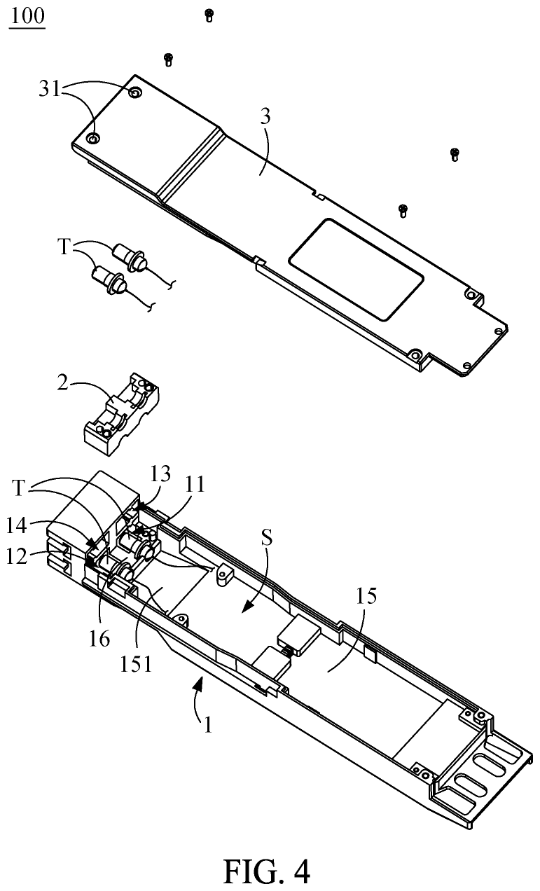

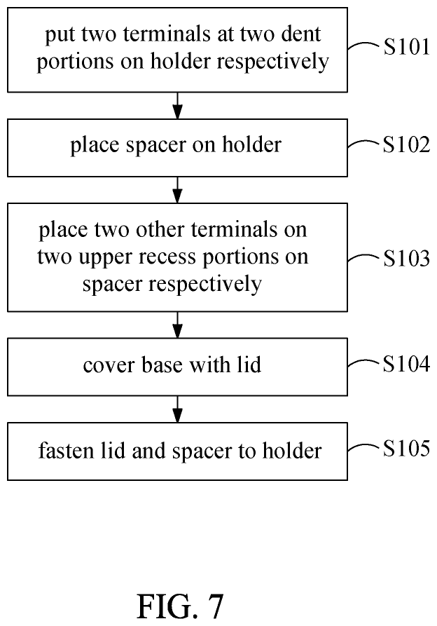

Referring to FIG. 4 through FIG. 7, an assembly method of the octal small form factor pluggable (OSFP) 100 according to the present disclosure is provided.

Referring to FIG. 4, in step S101, two terminals T are disposed at two dent portions 161 on the holder 16, respectively.

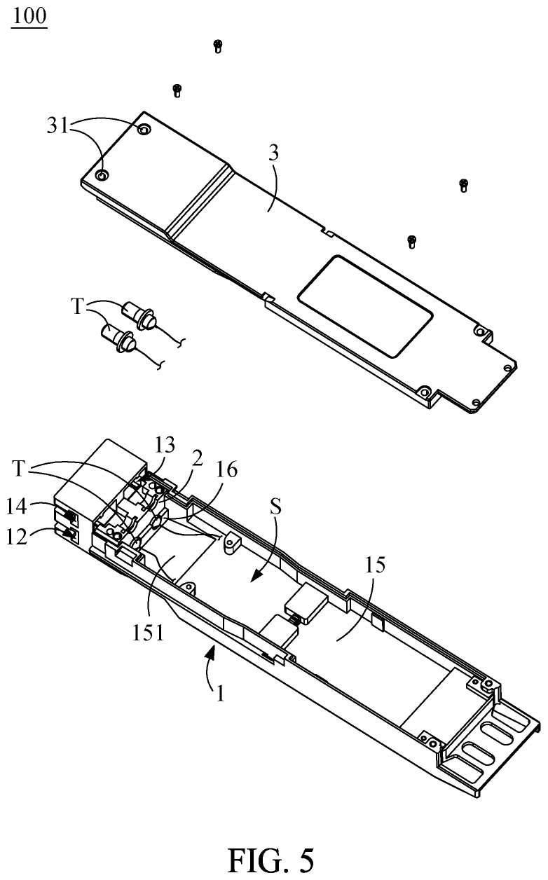

Referring to FIG. 5, in step S102, the spacer 2 is placed on the holder 16. Meanwhile, the lower recess portions 21 of the spacer 2 and the dent portions 161 of the holder 16 clamp terminals T.

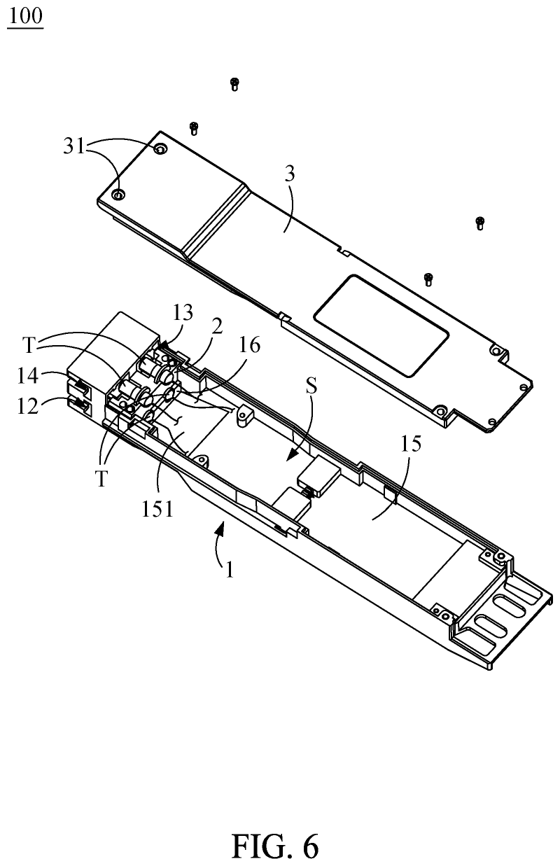

Referring to FIG. 6, in step S103, two other terminals T are placed on the two upper recess portions 22 on the spacer 2, respectively.

Referring to FIG. 1, the receiving portion 15 on the base 1 is covered with the lid 3 to complete the assembly of the octal small form factor pluggable (OSFP) 100.

According to the present disclosure, the octal small form factor pluggable (OSFP) 100 with the 4.0 specification is essentially dismantled into three constituent elements, namely the base 1, spacer 2 and lid 3, such that the four optical fiber ports 11, 12, 13, 14 are fixed to the base 1. The four optical fiber ports 11, 12, 13, 14 do not have assembly tolerance therebetween, neither do the four optical fiber ports 11, 12, 13, 14 and base 1. The base 1 and the spacer 2 each clamp four terminals. Therefore, not only is it easy and convenient to assemble the octal small form factor pluggable (OSFP) 100, but its constituent elements can also be easily produced and demolded.

According to the present disclosure, the assembly method of the octal small form factor pluggable (OSFP) 100 further comprises step S105: fastening the lid 3 and the spacer 2 to the holder 16. Referring to FIG. 2 through FIG. 3B, the holder 16 has two fastening holes 163, whereas the spacer 2 has two through holes 24 corresponding in position to the fastening holes 163. The lid 3 also has two through holes 31 corresponding in position to the fastening holes 163. Fastening-oriented screws pass through the through holes 31, through holes 24 and fastening holes 163 in sequence to fix the lid 3, spacer 2 and holder 16 in place.

Referring to FIG. 3A, in this embodiment, two transverse grooves 162 crossing the dent portions 161, respectively, are disposed on the upper surface of the holder 16. The transverse grooves 162 correspond in shape to the outer edges of terminals T to therefore prevent terminals T mounted on the holder 16 from sliding.

Referring to FIG. 3B, two transverse grooves 23 crossing the upper recess portions 22 and lower recess portions 21 are disposed on the upper and lower surfaces of the spacer 2. For the sake of brevity, FIG. 3B does not show the transverse grooves of the lower recess portions 21, because the transverse grooves of the lower recess portions 21 are similar to the transverse grooves 23 of the upper recess portions 22. Likewise, the transverse grooves 23 prevent terminals T mounted on the holder 16 from sliding.

Referring to FIG. 2, in this embodiment, the bottom of the receiving portion 15 has an oblique surface 151. The oblique surface 151 tilts toward the holder 16. The oblique surface 151 guides a connection line of the two lower terminals T, such that the connection line extends upward to therefore reach the same height and plane as the connection line of two other terminals T, thereby facilitating subsequent circuit connection.

The receiving space S receives a circuit board or any other device. The end of the junction of the lid 3 and the receiving portion has a gap. The connection lines of terminals T can be pulled out of the end.

While the present disclosure has been described by means of specific embodiments, numerous modifications and variations could be made thereto by those skilled in the art without departing from the scope and spirit of the present disclosure set forth in the claims.

1. An octal small form factor pluggable, comprising:
a base comprising four optical fiber ports located at four corners of an imaginary rectangle, respectively, a receiving portion and a holder, the four optical fiber ports being integrally formed at a front end of the base, the receiving portion being positioned proximate to the four optical fiber ports and having a receiving space, with the holder integrally formed in the receiving space and positioned proximate to two lower ones of the four optical fiber ports, wherein two dent portions corresponding in shape to terminals are disposed on an upper surface of the holder and correspond in position to the two lower optical fiber ports;
a spacer disposed above the holder, wherein two lower recess portions corresponding in shape to terminals are disposed on a lower surface of the spacer and adapted to clamp the terminals together with the dent portions, wherein two upper recess portions corresponding in shape to terminals are disposed on an upper surface of the spacer and positioned proximate to two upper ones of the four optical fiber ports; and
a lid for covering the receiving portion.

2. The octal small form factor pluggable of claim 1, wherein the upper surface of the holder further has two transverse grooves crossing the dent portions, respectively.

3. The octal small form factor pluggable of claim 1, wherein the lower surface of the spacer further has two transverse grooves crossing the upper recess portions, respectively.

4. The octal small form factor pluggable of claim 1, wherein the upper surface of the spacer further has two transverse grooves crossing the lower recess portions, respectively.

5. The octal small form factor pluggable of claim 1, wherein the holder has two fastening holes, whereas the spacer and the lid each have two through holes corresponding in position to the two fastening holes.

6. The octal small form factor pluggable of claim 1, wherein a bottom of the receiving portion has an oblique surface.

7. (canceled)

8. (canceled)
